(19) United States
(12) Patent Application Publication
(10) Pub. No.: US 2013/0283752 A1
(43) Pub. Date: Oct. 31, 2013

(54) LINE TRIMMER

(71) Applicant: Robert Bosch GmbH, Stuttgart (DE)

(72) Inventors: John Lister, Bury St. Edmunds (GB); Robert Davidson, Cambridge (GB); Mark Glanville, Ipswich (GB)

(21) Appl. No.: 13/846,317

(22) Filed: Mar. 18, 2013

(30) Foreign Application Priority Data
Mar. 19, 2012 (EP) 12160082.9-1260

(51) Int. Cl. A01D 34/416

(52) U.S. Cl. CPC A01D 34/4161; A01D 34/4162; A01D 34/4163
USPC 56/295; 30/347

(57) ABSTRACT

A line trimmer or mower head includes an automatic and/or manual line feed system with reduced tendency for cut and worn line to retract fully back into the spool housing. The line trimmer includes a rotatable spool assembly of at least one feedable line, at least one primary wall member adjacent a periphery of said spool assembly and a guide passage extending generally radially away from said primary wall member. The guide passage is partly defined by a substantially radially extending first formation arranged to bear upon line extending through said guide passage, such that in use line located within said guide passage is restricted to a substantially radial orientation.

This application claims priority under 35 U.S.C. §119 to patent application no. EP12160082.9-1260, filed on Mar. 19, 2012 with the European Patent Office, the disclosure of which is incorporated herein by reference in its entirety.

This disclosure is concerned with a line trimmer or mower head. In particular it is concerned with a line trimmer or mower head having an automatic and/or manual line feed system with reduced tendency for cut and worn line to retract fully back into the spool housing. For the sake of convenience the term ‘line trimmer’ herein is intended to include within its scope a ‘mower head’ arrangement.

### BACKGROUND

Line trimmers or mower heads are known for cutting grass and similar vegetation, which comprise at least one length of cutting cord (or ‘line’ herein) wound around a rotatable spool, which pays out one or more externally projecting lengths of line. Rapid rotation of the spool and line projecting therefrom, typically by electric or petrol motor applies a centrifugal load on the projecting line which becomes the cutting line to cut the grass or vegetation.

Trimmer line feed mechanisms are well known which permit the length of exposed cutting line to be increased when this part of the line breaks or wears below acceptable levels. Such paying out of line from its winding can be effected without replacing the line. In some versions of trimmer it may be effected automatically during use and/or manually by the operator as in ‘bump’ feeding.

For example the skilled reader is referred to the construction of line trimmers disclosed eg in W0-2007/032,043 and W0-2010/082,347.

Additionally, line trimmer spools are known with radiused or splayed exit guides for the external cutting line as in U.S. Pat. No. 7,111,403 and EP 1 585 380 whereas external cutting line exits are also known with other protective means in, for example, EP 1 942 717, EP 2 107 866, and U.S. Pat. No. 4,114,269.

In line trimmers of these latter types, the external line can still break or wear too close to the outer surface of the feed mechanism, whereupon the end of the line (or lines where more than one is present) can retract back inside the spool mechanism, which can prevent the spool line feed mechanism from being able properly to feed or pay out fresh line.

Similarly, there can be problems with automatic feed systems in which a minimum length of line needs to project beyond its housing, for that system to feed out new line. Should the line break at or wear down to a length shorter than this critical length, the automatic feed system is unable to feed out more line.

### SUMMARY

The present disclosure seeks to reduce the likelihood of occurrence of a major frustration currently suffered with manual “bump” and/or automatic line feed heads, namely line breakage or wear too close to the internal spool winding which renders the system unable to feed out. Typically in such situations the broken line retracts back into the spool chamber toward the spool winding, which creates even more problems for the user. The disclosure accordingly seeks to provide a line trimmer or mower head with a manual and/or automatic line feed system but wherein the cutting line is less likely to break too close to the spool winding and housing.

The disclosure further seeks to provide a line trimmer or mower head with a line feed mechanism, be it manual “bump” and/or fully automatic, which allows the spool of wound line within the head to unwind a little, thereby releasing line to replace that worn or broken, and wherein the remaining unworn/unbroken length of line is still able to generate enough tension in use to unwind the spool.

Essentially, according to this disclosure there is provided a line trimmer including a rotatable spool assembly of at least one feedable line, at least one primary wall member adjacent a periphery of said spool assembly, a guide passage extending generally radially away from said primary wall member, said guide passage being partly defined by a substantially radially extending first formation arranged to bear upon line extending through said guide passage, such that in use line located within said guide passage is restricted to a substantially radial orientation.

Further preferred and optional features of the disclosure may be found amongst the description herein.

### BRIEF DESCRIPTION OF THE DRAWINGS

In order that the disclosure may be illustrated, more easily appreciated and readily carried into effect by those skilled in this art, embodiments of line trimmers according to the disclosure will now be described purely by way of non-limiting example with reference to the accompanying drawings and in which:

FIG. 1 is an exploded diagrammatical view of a line trimmer head according to a first preferred embodiment,

FIG. 2 is an enlarged schematic view of part of the assembly shown in FIG. 1, particular depicting one of the guide passages, and

FIG. 3 is a schematic plan view (in partial cutaway), of the FIGS. 1 and 2 assembly, showing the internal arrangement of spool relative to one guide passage.

### DETAILED DESCRIPTION

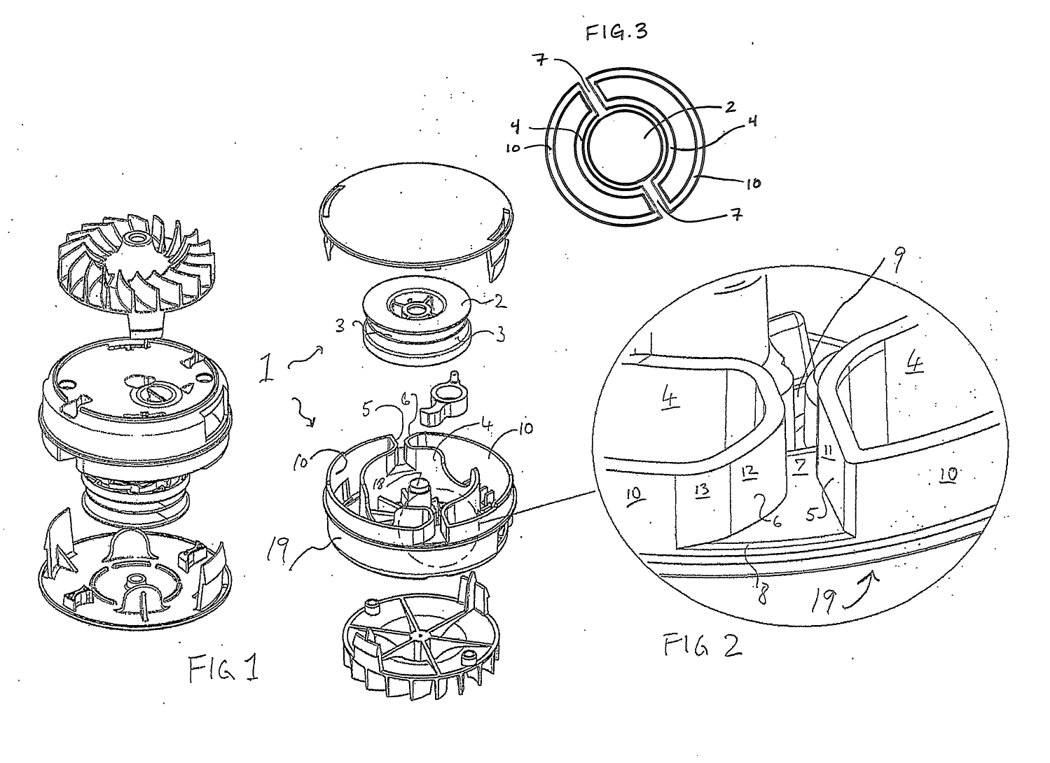

Referring to the drawings and firstly to FIGS. 1-3 thereof, a line trimmer head 1 in exploded view is shown comprising a rotatable spool 2 with two regions 3 to accommodate wound line (not shown). The spool 2 is to be mounted upon an axial spigot 18 located generally centrally within a spool housing 19. A primary wall member 4 is located in close proximity to the periphery of the spool when rotatably mounted. It is an upstanding part-circular component and two similar such primary wall members are provided, one opposite the other, generally to surround the outer periphery of the spool.

Additionally, the spool housing comprises a pair of secondary wall members 10 each spaced apart from a primary wall member but connected thereto by first and second formations of the primary wall member which define a guide passage 7 within which line from the spool is located and can be fed out. The secondary wall members are similarly upstanding and part circular. As shown more clearly in FIG. 2, one guide passage formation 11 is generally straight and radially disposed with respect to the spool axis. In use, this guide passage formation is arranged to be ‘leading’ hence moving ahead of and protecting the line in the normal direction of spool rotation. This first formation 11 creates a linking member between spaced apart primary and secondary wall members.

Opposite the first formation 11 is a second formation 12, 13 of a different profile and also serving partly to define the guide passage 7 which extends from an internal opening 9 to an external opening 8. The said second formation 12, 13 is partly radially extending and partly curved away (at 13) from its radially extending portion serving to widen the opening 8 relative to the width of the internal opening 9. In use, this guide passage formation is arranged to be ‘trailing’ with its profile therefore allowing some momentary flexing of the line in use against solid objects while still maintaining substantially radial guidance.

Conveniently the primary and secondary wall members 4, 10 including the first and second formations of the primary wall members (11 and 12, 13 respectively) can be of one-piece and preferably integral construction. In the illustrated arrangement there are two guide passages 7 so here a spool is used with two wound lines. The lines are to pass through the said guide passages 7.

The primary wall members 4 serve to provide primary protection to the rotatable spool and the wound line contained thereon, and assist in defining the internal opening 9 to the guide passage. The secondary wall members 10 serve to provide secondary protection to the internal working length of line and assist in defining the outer opening 8 of the guide passage. Accordingly it can be seen that primary wall members 4 are of sufficient height to enclose the full depth of the spool while secondary wall members 10 which enclose the line guide passage(s) may be of lesser height. Such lesser height could be such as to provide only a guide passage outlet depth of two line diameters.

Whilst the preferred embodiment of FIGS. 1 and 2 show a particularly preferred form of profiled guide passage, profiling being dictated by shape and contour of the said first and second formations (11 and 12, 13 respectively) which extend between primary and secondary wall members, other forms of guide channel are possible. For example as shown in FIG. 3 herein, the guide passage is almost entirely radial in the sense that the connecting formations between primary and secondary wall members are generally linear and spaced but also substantially parallel. Other configurations of guide channel will be apparent to those skilled in the art and are intended to be included within the scope of the description.

Referring back to FIGS. 1 to 3 more particularly, the line trimmer feed system has two generally concentric walls that assist in feeding of the line, the outer wall acting as a guard that prevents the line being damaged or broken at any diameter less than that of the outer wall. This ensures a minimum length of line always remains within the guide passage. Sufficient length of line remains after breakage or wear of working line beyond the guide passage to operate any automatic feed system.

In all embodiments while passing through the guide passage, the line is guided/restrained to be substantially radial.

The length of the guide passage providing working line guidance is set such that if the line does break off at the external opening of the guide passage, the line tension generated under centrifugal loading from the remaining line length remains adequate to rotate the spool and feed out more line. The spacing between inner and outer walls and hence length of the guide passage to achieve this is preferably 15-25 mm, more preferably 16-24 mm, most preferably 18-22 mm such as about 20 mm. The guidance/restraint provided by the guide passage prevents the remaining line momentarily from moving to too small a working radius with consequent loss of tension.

Even under abusive conditions, guidance provided by the guide passage prevents the user from breaking the line with too small a working radius and reliable line feed is therefore assured.

Embodiments of the present disclosure can resolve one of the major frustrations with either bump or automatic line feed heads, all of which currently can suffer from line breakage at their eyelet and then being unable to feed line out from the spool winding. Usually, in such circumstances what is left of the working line disappears back inside the spool chamber, which has tended to create even more problems for the user.

1. A line trimmer, comprising:
a rotatable spool assembly of at least one feedable line;
at least one primary wall member adjacent a periphery of said spool assembly; and
a guide passage extending generally radially away from said at least one primary wall member, wherein said guide passage is partly defined by a substantially radially extending first formation arranged to bear upon line extending through said guide passage, such that in use line located within said guide passage is restricted to a substantially radial orientation.

2. The line trimmer as claimed in claim 1, further comprising at least one secondary wall member that is spaced away from said primary wall member.

3. The line trimmer as claimed in claim 2, wherein a spacing between the at least one primary wall member and the at least one secondary wall member and a length of the guide passage are about 15 to 25 mm.

4. The line trimmer as claimed in claim 1, wherein:
the guide passage has an inlet adjacent the spool assembly and an outlet spaced away from the spool assembly, and
a vertical channel depth of the guide passage outlet is approximately equivalent to from 1 to 4 line diameters.

5. The trimmer as claimed in claim 1, wherein the at least one primary wall member is configured to extend around a majority of the periphery of the spool assembly.

6. The trimmer as claimed in claim 1, wherein:
the guide passage is further partly defined by a second formation generally opposite the first formation, and
the second formation extends generally radially away from another part of the at least one primary wall member.

7. The trimmer as claimed in claim 4, wherein the guide passage inlet is circumferentially narrower than the guide passage outlet.

8. The trimmer as claimed in claim 6, wherein:
the second formation has at least one generally radially extending portion that partly defines the guide passage, and
the second formation has a curved portion extending away from said generally radially extending portion.

9. The trimmer as claimed in claim 8, wherein the at least one primary wall member and the at least one secondary wall member are connected by the first formation.

10. The trimmer as claimed in claim 6, wherein the at least one primary wall member and the at least one secondary wall member are connected by said second formation.

11. The trimmer as claimed in claim 1, wherein the at least one primary wall member and said first formation are integrally formed.

12. The trimmer as claimed in claim 6, wherein the at least one primary wall member and the at least one secondary wall member are configured as projecting part cylindrical components generally concentrically located about an axis of rotation of said spool assembly.

13. The trimmer as claimed in claim 9, wherein the at least one primary wall member, the at least one secondary wall member, said first formation, and said second formation are integrally formed.

14. The trimmer as claimed in claim 1, wherein the spool assembly is configured such that, when the at least one feedable line breaks at a guide passage opening remote from the spool assembly, a line tension under centrifugal loading from a remaining length of line remains sufficient to unwind the spool assembly and feed out more line.

15. The line trimmer as claimed in claim 6, wherein the guide passage, the first formation, and the second formation are configured to prevent line within the guide passage momentarily from moving to a radius with a line tension inadequate to unwind the spool assembly.

16. The line trimmer as claimed in claim 1, wherein said first formation comprises an extended portion of said at least one primary wall member.

17. The line trimmer as claimed in claim 6, wherein said second formation comprises an extended portion of said at least one primary wall member.

18. The line trimmer as claimed in claim 1, wherein the spool assembly includes at least one of an automatic feed mechanism and a bump line feed mechanism.
